(19) United States
(12) Patent Application Publication
(10) Pub. No.: US 2012/0216492 A1
(43) Pub. Date: Aug. 30, 2012

(54) DRAGONFLY REIN ASSEMBLY

(76) Inventor: Douglas G. Ehrmann, Chester, NY (US)

(21) Appl. No.: 12/998,734

(22) PCT Filed: Feb. 25, 2011
(86) PCT No.: PCT/US11/00350

§ 371 Date: May 25, 2011

(51) Int. Cl. B68B 1/04

(52) U.S. Cl. 54/36

(57) ABSTRACT

A dragonfly rein assembly (10, 210, 310, 410) is described as being formed around a uniquely structured chin control link (12, 12A, 12B) which interacts with bit rings and reins (20, 220, 320, 420) of various types to provide a number of desirable horse and rider benefits. A flexible link (16, 16A, 16B) of predetermined length is deployed under the horse's chin and releasably affixed by a pair of coupling elements (14L, 14R) to the bit rings. The forward ends of the reins when affixed to the pair of couplings (14L, 13R) thereby transfer control pressures to the bit via the chin control link (12, 12A, 12B) while preventing pulling of the bit through the horse's mouth. A wide range of benefits for both horse and rider result from these interactions, including significant calming, improved riding and humane handling during all phases of use.

### TECHNICAL FIELD

The present invention relates generally to methods and apparatus directed to improving the handling, training and riding of horses, and more particularly to a unique chin control link adapted for use in combination with a variety of rein types. The invention described mitigates the undesirable effects of pulling a bit through the horse's mouth when pressure is applied to one rein or the other, thereby providing a number of significant calming, riding and humane handling advantages.

### BACKGROUND

A great amount of attention and creative effort has been expended over the years for the purpose of providing improved methods and apparatus for controlling horse handling and performance during the wide range of activities horses and riders engage in. Serious equestrian-minded people of all stripes, including trainers, riders, farriers, owners, plus others, all have felt the need for making changes to tack to bring about calmer and more positive handling of horses, as well as for minimizing their discomfort from bits, bridles, harnesses and the like. The benefits sought include improving horse set, framing, smooth and balanced turning and stopping, as well as minimizing head shaking, and other well known undesirable horse actions.

These efforts have produced a myriad of devices and techniques, all of which contribute in some degree to improved performance from rider and horse. Contemporary trade publications describe and illustrate some of the vast number of innovative equine products available—from bridlework to snaffles to reins, and beyond. The interested reader is directed to the Spring 2011 Weatherbeeta Wholesale catalog for over 100 pages of equine products. Additionally, brief reference to the Spring 2010 trade publication Tack'nTags provides another source of creative products in its “Best and New Products for 2010” section. In this section a panel of judges chooses the best and brightest out of an enormous field of entries, and we note in particular one winner, a horse-friendly Easy Lead described on page 55, plus others on page 53.

A significant number of these creative efforts are also reflected in the patent literature. Typical prior patent art teachings and descriptions pertinent to the present invention are found U.S. Pat. No. 4,492,073 to Finke and in U.S. Pat. No. 7,373,766 to Watkins, among others.

The 1958 '073 Finke patent discloses s ‘bitting ring’ apparatus whose function is to train a horse to set its head as detailed its column 2 beginning at line 44. Note in particular the under-the-chin member 20 and snaps which attach to the bit shanks at the bit ends. The functioning of member 20 is set forth as causing the horse to maintain a predetermined headset.

The 2008 '766 patent to Watkins discloses the use of a chin band to transmit forces applied through reins via an enhancing link through the sidepiece. The arrangement is disclosed in a bit-less bridle system, however, the broad subject of transferring opposite side forces appears clearly.

U.S. Pat. No. 3,263,397 to Faragher discloses a halter-bridle combination having a chin strap looped through rings. Its reins are snap releasable to the bit curb or may be affixed to the ring carried by the chin strap. These structures, however, appear to be directed to the dual purposes of riding/curbing.

U.S. Pat. No. 9,999,457 to Roberts for a precision rein system is of interest for its showing of using a range of attaching means for attaching adjustable length reins to bit ends, reciting J-hooks or buckles and the like.

Additional U.S. patent documents are of general interest for their teachings of equine-related handling and controlling devices of various sorts. These are U.S. Pat. No. 6,705,064 to Grissom, U.S. Pat. No. 6,349,527 to Keppick, U.S. Pat. No. 5,148,382 to Meaghan and U.S. Pat. No. 1,643,382 to Wiesenfeld.

It should be noted that these prior art patent documents show only somewhat related aspects or minor subcombinations of the features taught in the present invention. More significantly, not one of these prior art documents taken by itself or in combination with the others either teaches or suggests the unique chin control link of the present invention, nor its salutary interactions with the reins and bits. Additionally, while each of these prior art teachings show approaches that function more or less well for its intended purposes, they have not provided an approach that achieves the wide range of benefits provided by the chin control link based dragonfly rein assembly disclosed herein. It is exactly these significant benefits and needs that the present invention admirably meets.

### OBJECTS OF THE INVENTION

It is therefore a primary object of the present invention to provide improved methods and apparatus for controlling, training and handling horses via means affixed to bits or bridles such that both horse and rider experience a more positive and less stressful outcome.

A further object of the present invention is to provide a flexible control link used in combination with known bit/bit rings and reins so as to prevent or minimize pulling the bit through the horse's mouth.

A still further object of the present invention is to provide a chin control link having a central flexible link fabricated from a range of known materials, and a pair of quick-connect elements at its outer ends for attaching to left and right bit rings via the first of the connector element ends and eyes at the second of the connector element ends for receiving the ends of a pair of reins.

In preferred and alternate embodiments the structural and functional relationships between the unique chin control link and the bit rings and reins to which it is attached are revealed and described. The primary function of the chin control link is clarified as interacting with control pressures from one rein or the other to impart the desired control signals while preventing the bit from being pulled through the horse's mouth. This greatly reduces the mount's discomfort and also provides several unexpected and beneficial horse responses and performance actions. The chin control link and its flexible link and a pair of quick-connect elements, such as snaps, may be fabricated from a variety of materials and a number diverse means for interconnecting it with the bit rings and reins are described.

### BRIEF DESCRIPTION OF THE DRAWINGS

Additional objects and advantages of the invention will become apparent to those skilled in the art as the description proceeds with reference to the accompanying drawings, wherein:

FIG. 1 is a left side view of the dragonfly rein assembly according to the present invention shown in use with an illustrative equine harness;

FIG. 2 shows a preferred embodiment of a chin control link for use with the dragonfly rein assembly of the present invention;

FIG. 3 is an alternate preferred embodiment of a chin control link for use with the dragonfly rein assembly of the present invention showing alternate materials and end loop connections;

FIG. 4 shows an additional preferred embodiment of an overall dragonfly rein assembly ready for use;

FIG. 5A shows a dragonfly rein assembly employing a single, continuous loop rein; and

FIG. 5B shows a dragonfly rein assembly employing a split rein whose ends meet in a rider's hands.

### BEST MODE FOR CARRYING OUT THE INVENTION

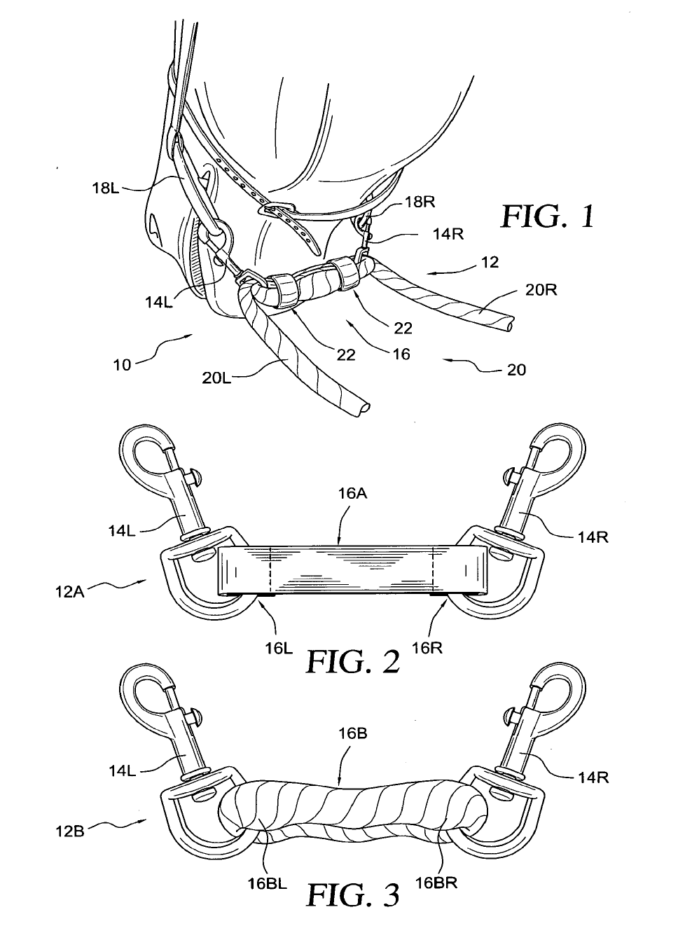

Referring now to FIG. 1 there is shown a left side view of a dragonfly rein assembly in combination with a conventional bridle in actual use on a horse. In the preferred embodiment depicted, a dragonfly rein assembly 10 is made up of a chin control link 12 comprising a pair of left and right swivel snaps 14L and 14R at the ends of a short, flexible link 16. The snaps 14L/R are releasably attached to the left and right sides of bit dee rings 18L/R respectively. Connected through the eye portions of snaps 14L/R are left and right reins ends 20L and 20R of reins 20. The elements 12 and 20 constitute the dragonfly reins assembly 10 of this embodiment. The remaining bridle, reins and related elements are depicted for illustrative purposes do not form part of the present invention.

The flexible link 16 is shown as being made of poly rope of predetermined fixed length each of whose ends is formed into a link loop disposed around the eye portions of the snaps 14L/R. The link loop ends of the link 16 may be either woven together around their respective rings, or may be formed into ring-retaining loops by being clamped by one or more clips or clamps 22.

In an alternate preferred embodiment, the chin control link 12 may include a flexible link 16A, which may be made of leather or other suitably strong and flexible materials such as other types of rope products, woven materials, plastics, synthetics, rubber or rubber/fiber composites. Referring briefly now to FIG. 2, a leather link 16A of chin control link 12A is depicted as being retained between snaps 14L and 14R. The two ring-retaining link loops 16L and 16R of 16A may be formed by stitching, clipping, weaving, riveting, stapling, thermal welding, molding or other well known leather, plastic or synthetics fastening means. In FIG. 3 another alternate preferred embodiment of the chin control link 12B is depicted as being formed from poly rope 16B retained between snaps 14L and 14R by means of woven link loops 16BL and 16BR at each end. The link clip-retained poly rope embodiment of FIG. 1, the sewn leather embodiment of FIG. 2 or the woven loop-retained embodiment of FIG. 3 each provides a robust, flexible and serviceable flexible link for the dragonfly rein assembly.

In each embodiment, the length of the flexible link is established so as to correlate with the distance between the bit rings as determined by a curved under-the-chin length measurement. It has been found that the flexible links 16, 16A and 16B function best when they are made in lengths of approximately between one half and three quarters of the under-the-chin distance.

The coupling elements shown are, for simplicity of presentation, all of the swivel eye bolt snap type. In alternate preferred embodiments other coupler types, such as swivel strap eye bolt snaps, wide jaw quick links, and carabiners may be used.

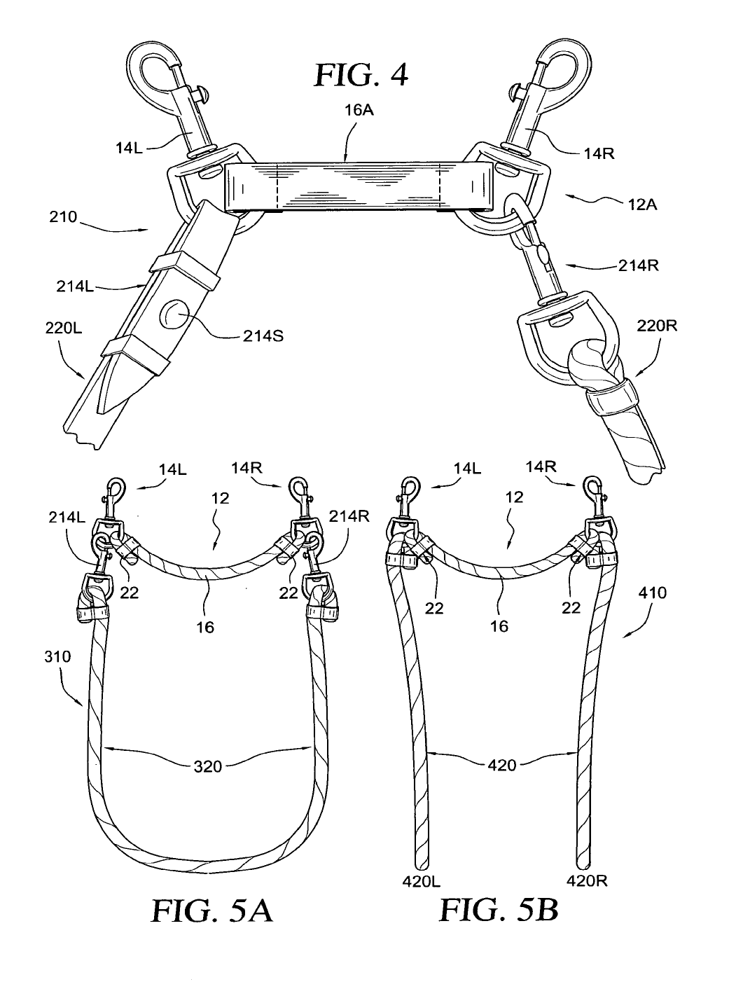

Regarding FIG. 4, there is shown an alternate preferred embodiment of an overall dragonfly rein assembly ready for use. As with the embodiment of FIG. 1, this embodiment includes the basic components associated with reins 20 but in modified form. In particular, the ends of the reins and their means of attachment to the chin control link 12A show variations which have proven to be highly advantageous. Whereas the right rein end 20R of FIG. 1 was connected through the eye of snap 14R, the right rein end 220R is affixed to the eye portion of a snap 214R by a clip-retained or woven loop. The snap 214R is then clipped to the eye portion of snap 14R, thus affording not only a quick disconnect capability but also allowing the basic chin control link 12A to be readily used with a range of different reins.

Also, whereas the left rein end 20L of FIG. 1 was connected through the eye of the snap 14L, the end 220L is affixed by a belt/strap arrangement 214L. Again, the loop of the belt is readily threaded through the eye portion of snap 14L enabling an alternate quick connect/disconnect capability. A stud 214S may serve to retain the strap loop. Alternately a conventional belt/buckle arrangement may be employed. Additionally, whereas the dragonfly reins assembly 10 of FIG. 1 comprises both elements 12 and 20 or their equivalents, the dragonfly reins assembly 210 of FIG. 4 comprises only the element 12 or its equivalents. Clearly, modifications to the arrangements shown in FIG. 4 may involve the use of a pair of snaps 214R (and 214L not shown) as well as the use of a pair of belts 214L (and 214R not shown) rather than the mixed combination shown. Recalling that the dragonfly reins 10 comprises elements 12 and 20 while the dragonfly reins 210 comprises only the element 12 or its equivalents, it is useful at this point to describe the various forms the reins 20 or 220 may take and how they interact operationally with their various embodiments.

Referring to FIGS. 5A and 5B, two distinct rein types amenable for use in the present invention are shown. FIG. 5A shows a dragonfly rein assembly 310 in use with a single rein 320 which goes from one side of the bit to the other in a continuous loop. The forward ends of reins 320 are releasably affixed to the chin control link 12A as described in connection with FIG. 4.

FIG. 5B shows a dragonfly reins assembly 410 employing split reins 420 which have open ends 420L and 420R which meet in the rider's hands. The forward ends of reins 420 are affixed to the chin control link 12 as described in connection with FIG. 4.

As all proficient riders are aware, ideal interactions between horse and rider occur when both are attuned through very subtle signals and reactions. Thus the present chin control link functions to produce improved controlling and riding by an unexpected effectiveness deriving in substantial part from preventing, or greatly minimizing, pulling the bit through the mouth, and thereby possibly by allowing more subtle signaling to the horse.

However, the best measures of the advantages provided by the present invention are best found from actual useage. Empirical results show that balance of the bit that comes from not pulling the bit through then mouth also stops a horse from head shaking, a side effect from an uncomfortable mouth. Field observations also show that use of the present invention causes horses to be calmer allowing for better transitions from walk to trot to canter, and the like. Use of the dragonfly rein assembly tends to straighten out the horse when going forward. When riding to the left in a straight line and the horse's back end tends not to follow his front feet wandering out. Simply applying more left rein pressure will result in pulling the left side of the mouth up, which is what happens with traditional reins. Instead the present reins will bring the back end in line with the front feet and straighten the whole body.

Because the bit is balanced and level in the mouth, bending is made easy. Pulling the whole mouth and bit instead of pulling the bit through the mouth on one side leads to allowing the horse to bend from head to hip easily around corners while riding. And, stopping a horse is more balanced because the chin control link tends to keep the reins more even when pulling back.

Getting the horse in frame is also much easier. This means each horse in its ultimate position for riding depending on the discipline in use. For example, when riding with English equipment horses should easily tuck their head and nose in towards the neck and head set lower.

Although the invention has been described in terms of preferred and alternate embodiments, the invention should not be deemed limited thereto since modifications will readily occur to one skilled in the art. It is therefore to be understood that the appended claims are intended to cover all such modifications as fall within the true spirit and scope of the invention.

What is claimed is:

1. An equine rein assembly for providing improved handling, training and controlling of a horse comprising:
(a) a chin control link having a flexible link of predetermined length, said flexible link having a link loop at each of its two ends;
(b) first and second coupling elements each retained in only one of said link loops;
(c) whereby upon attaching said first and second coupling elements to bit rings on opposite sides of a bit assembly and further attaching each end of a pair of reins to each of the coupling elements, control pressure applied via one rein or the other minimizes the pulling of the bit through the horse's mouth.

2. The rein assembly of claim 1 wherein said flexible link has a length less than the under-the-chin distance between the two bit rings and is made from materials selected from the group including leather, rope, woven fabrics, synthetic/plastics, rubber and rubber/fiber composites.

3. The rein assembly of claim 1 wherein said link loops are formed by processes taken from the group including stitching, clipping/clamping, weaving, stapling, riveting, thermal welding and molding.

4. The rein assembly of claim 1 wherein said coupling elements are formed in two interconnected portions a first portion having a manually actuated opening at its bit attaching end and a second portion having an eye at its flexible link attaching end.

5. The rein assembly of claim 4 wherein said coupling elements are swivel eye bolt snaps and said two portions are interconnected by a swivel.

6. A method of using an equestrian rein assembly attached to bit rings and reins of a horse comprising the steps of:
(a) providing a chin control link having a flexible link of predetermined fixed length, said flexible link having a link loop at each of its two ends;
(b) providing first and second coupling elements each retained in only one of said link loops;
(c) affixing each of said first and second coupling elements to a bit ring on opposite sides of a bit assembly;
(d) attaching each end of a pair of reins to one of the coupling elements; and
(e) whereby upon applying control pressure to one rein or the other the tendency of pulling the bit through the horse's mouth is minimized.

7. A method of using the equestrian rein assembly of claim 6 further comprising the step of providing a flexible link having a length less than the under-the-chin distance between the two bit rings which is made from materials selected from the group including leather, rope, woven fabrics, synthetic/plastics, rubber and rubber/fiber composites.

8. A method of using the equestrian rein assembly of claim 6 further comprising the step of providing link loops formed by processes taken from the group including stitching, clipping/clamping, weaving, stapling, riveting, thermal welding and molding.

9. A method of using an equestrian rein assembly of claim 6 further comprising the step of providing coupling elements formed in two interconnected portions with a first portion having a manually actuated opening at its bit attaching end and a second portion having an eye at its flexible link attaching end.

10. A method of using an equestrian rein assembly of claim 6 further comprising the step of providing coupling elements selected from the group including swivel eye bolt snaps, swivel strap eye bolt snaps, wide jaw quick links, and carabiners.

11. An equine rein assembly for providing improved handling and controlling of a horse using a chin control link and a pair of reins interacting with a bit positioned in the horse's mouth comprising:
(a) a chin control link having a flexible link of predetermined length, said flexible link having a link loop at each of its two ends;
(b) first and second coupling elements each retained in only one of said link loops;
(c) a pair of reins having left and right ends;
(d) whereby upon attaching said first and second coupling means to bit rings on opposite sides of a bit assembly and further attaching one end of said pair of reins to the opposite sides of the bit rings, control pressures applied via one rein or the other minimizes the pulling of the bit through the horse's mouth.

12. The equine rein assembly of claim 11 wherein additional benefits resulting from said applied control pressure includes one or more horse responses taken from the group including reduced head shaking, reduced unsteady head movements, better transitions from walk to trot to canter, bringing the back end in line with the front feet, improved bending from head to hip when cornering and balanced stopping.

13. The equine rein assembly of claim 11 wherein said reins are formed as a continuous loop.

14. The equine rein assembly of claim 11 wherein said reins are formed as a split rein.

15. The equine rein assembly of claim 11 wherein said flexible link has a length less than the under-the-chin distance between the two bit rings and is made from materials selected from the group including leather, rope, woven fabrics, synthetic/plastics, rubber and rubber/fiber composites.

16. The equine rein assembly of claim 10 wherein said link loops are formed by processes taken from the group including stitching, clipping, weaving, stapling, riveting, thermal welding and molding.

17. The equine rein assembly of claim 11 wherein said coupling elements are formed in two interconnected portions a first portion having a manually actuated opening at its bit attaching end and a second portion having an eye at its flexible link attaching end.

18. The equine rein assembly of claim 11 wherein said coupling elements are swivel eye bolt snaps and said two portions are interconnected by a swivel.

19. The equine rein assembly of claim 11 wherein coupling elements are selected from the group including swivel eye bolt snaps, swivel strap eye bolt snaps, wide jaw quick links, and carabiners.

20. A method of using an equestrian rein assembly for providing improved handling and controlling of a horse using a chin control link and a pair of reins interacting with a bit positioned in the horse's mouth comprising:
(a) providing a chin control link having a flexible link of predetermined length, said flexible link having a link loop at each of its two ends;
(b) providing first and second coupling elements each retained in only one of said link loops;
(c) providing a pair of reins having left and right ends;
(d) whereby upon attaching said first and second coupling means to bit rings on opposite sides of a bit assembly and further attaching one end of said pair of reins to the opposite sides of the bit rings, control pressures applied via one rein or the other minimizes the pulling of the bit through the horse's mouth.
